(19) United States
(12) Patent Application Publication
(10) Pub. No.: US 2021/0071028 A1
(43) Pub. Date: Mar. 11, 2021

(54) PRIMER COMPOSITION, PRIMER COATING FILM AND FORMATION METHOD THEREFOR, AND FORMATION METHOD FOR COATING FILM

(71) Applicant: NIPPON PAINT INDUSTRIAL COATINGS CO., LTD., Shinagawa-ku Tokyo (JP)

(72) Inventor: Jyunsuke HOKKA, Shinagawa-ku, Tokyo (JP)

(73) Assignee: NIPPON PAINT INDUSTRIAL COATINGS CO., LTD., Shinagawa-ku Tokyo (JP)

(21) Appl. No.: 16/772,156

(22) PCT Filed: Oct. 24, 2018
(86) PCT No.: PCT/JP2018/039503

§ 371 Date: Jun. 12, 2020

(30) Foreign Application Priority Data
Dec. 19, 2017 (JP) 2017-242825

(51) Int. Cl. C09D 161/12; C09D 177/00; C09D 7/65; C09D 7/61; C09D 7/20; C09D 5/08

(52) U.S. Cl. CPC C09D 161/12; C09D 177/00; C09D 5/084; C09D 7/61; C09D 7/20; C09D 7/65

(57) ABSTRACT

Provided is a primer composition capable of forming, in a short time, a primer coating film excellent in adhesion to a metal substrate, adhesion to a polyamide resin-containing finish coating film, and corrosion resistance. A primer composition comprises: a phenol resin (A); a polyamide resin (B); and a solvent (C), wherein the phenol resin (A) is a resol-type phenol resin, the polyamide resin (B) is soluble in the solvent (C), and a solid content mass ratio (A/B) between the phenol resin (A) and the polyamide resin (B) is 80/20 to 99/1.

### TECHNICAL FIELD

The present disclosure relates to a primer composition, a primer coating film and a formation method therefor, and a formation method for a coating film.

### BACKGROUND

Metallic piping such as heavy-duty and anticorrosive steel piping for social infrastructure (water pipe bridges, seawater piping, plant piping, clean water facilities, various pipelines, etc.) and automobile parts (piping of brake system, fuel system, hydraulic system, etc.) is required to have high corrosion resistance. Hence, a protective coating is conventionally provided on the outer surface of metallic piping.

For example, for piping for water pipes, a galvanized steel pipe or the like is subjected to a chemical conversion treatment to prevent rust, and a finish coating film mainly composed of a thermoplastic resin such as a vinyl fluoride resin-based coating (paint), a vinylidene fluoride resin-based coating, or a polyamide (nylon) resin-based coating is formed on the treated galvanized steel pipe or the like with a primer coating film (primer layer) being provided therebetween. In particular, polyamide resin has excellent mechanical properties and other properties, and therefore is promising for use in metallic piping. However, the adhesion of polyamide resin to different materials is poor. Accordingly, various primer compositions to be provided between the metal substrate and the polyamide resin coating are proposed (PTL 1 to PTL 3 listed below).

### CITATION LIST

### Patent Literatures

PTL 1: JP 2009-1623 A

PTL 2: JP 2014-144995 A

PTL 3: WO 03/033173 A1

### SUMMARY

### Technical Problem

The primer composition mentioned above is required to have not only good adhesion to the metal substrate but also good adhesion to the polyamide resin coating as a finish coating film, and is accordingly required to have improved corrosion resistance. No existing primer composition, however, satisfies these performance requirements. Moreover, there is recent demand to, in coating of the primer composition, form the primer coating film in a short time in order to shorten the process in the coating line.

It could therefore be helpful to provide a primer composition capable of forming, in a short time, a primer coating film excellent in adhesion to a metal substrate, adhesion to a polyamide resin-containing finish coating film, and corrosion resistance.

It could also be helpful to provide a primer coating film excellent in adhesion to a metal substrate, adhesion to a polyamide resin-containing finish coating film, and corrosion resistance, a formation method for the primer coating film in a short time, and a formation method for a coating film excellent in adhesion to a metal substrate and corrosion resistance.

### Solution to Problem

We provide the following.

A primer composition according to the present disclosure comprises: a phenol resin (A); a polyamide resin (B); and a solvent (C),

wherein the phenol resin (A) is a resol-type phenol resin,

the polyamide resin (B) is soluble in the solvent (C), and

a solid content mass ratio (A/B) between the phenol resin (A) and the polyamide resin (B) is 80/20 to 99/1.

The use of the primer composition according to the present disclosure enables formation of a primer coating film excellent in adhesion to a metal substrate, adhesion to a polyamide resin-containing finish coating film, and corrosion resistance in a short time.

In the present disclosure, the expression “the polyamide resin (B) is soluble in the solvent (C)” means that a solution obtained by adding 10 g of the polyamide resin (B) to 100 ml of the solvent (C) and stirring the mixture at 80° C. for 3 hr is colorless and transparent.

In a preferred embodiment of the primer composition according to the present disclosure, the phenol resin (A) contains two or more methylol groups in one molecule. In this case, the primer composition has excellent reactivity, and thus is capable of coating film formation in a short time. The solvent resistance of the formed primer coating film is therefore further improved.

The number of methylol groups in the phenol resin (A) can be calculated from the amount of generated water according to the following procedure.

(1) 500 g of phenol, 250 ml of benzene, and 15 g of p-toluenesulfonic acid are placed in a flask in which a fractionating column is set, and heated until boiling. After removing moisture in the flask, the contents are cooled.

(2) The flask was charged with 20 g of the phenol resin (A) (measurement sample) from which a contained solvent has been removed by drying at low temperature. The flask is heated to boil the contents, and the amount of water generated as a result is measured. The measured amount of water is substituted into the following (Formula 1) to calculate the methylol group equivalent, and the number of methylol groups is calculated according to the following (Formula 2). The “moisture in measurement sample (mass %)” in (Formula 1) can be measured, for example, by Karl Fischer titration.

Herein, the “generated water” means that, as a result of reaction between the methylol groups in the phenol resin (A) and phenol, one water molecule is generated per methylol group in the phenol resin (A). The number-average molecular weight in (Formula 2) is a value obtained by converting a measurement by gel permeation chromatography (GPC) (described later) in terms of polystyrene.

Methylol group equivalent (g/eq)=18×100/[amount of generated water (ml)×100/(20−moisture in measurement sample (mass %))] (Formula 1).

Number of methylol groups=number-average molecular weight/methylol group equivalent (Formula 2).

Preferably, in the primer composition according to the present disclosure, a number-average molecular weight of the phenol resin (A) is 200 to 1,500. In this case, the adhesion between the primer coating film formed from the primer composition and the polyamide resin-containing finish coating film can be further improved.

Herein, the number-average molecular weight is a value obtained by converting a measurement by gel permeation chromatography (GPC) in terms of polystyrene.

Preferably, the primer composition according to the present disclosure further comprises a rust preventive pigment (D). In this case, the corrosion resistance of the primer coating film formed from the primer composition and the corrosion resistance of a coating film including the primer coating film can be further improved.

Preferably, the rust preventive pigment (D) contains at least one rust preventive pigment selected from the group consisting of a calcium silica-based rust preventive pigment and a phosphate-based rust preventive pigment. In this case, the corrosion resistance of the primer coating film formed from the primer composition and the corrosion resistance of the coating film including the primer coating film can be further improved.

A primer coating film according to the present disclosure is formed using the foregoing primer composition. The primer coating film according to the present disclosure is excellent in adhesion to a metal substrate, adhesion to a polyamide resin-containing finish coating film, and corrosion resistance.

A formation method for a primer coating film according to the present disclosure comprises applying the foregoing primer composition onto a coated matter, and heating the coated matter having the primer composition applied thereon to 200° C. to 300° C., to form the primer coating film. With the formation method for a primer coating film according to the present disclosure, a primer coating film can be formed in a short time.

A formation method for a coating film according to the present disclosure is a formation method for a coating film that includes a primer coating film and a finish coating film, the formation method comprising

forming the finish coating film from a finish coating composition containing a thermoplastic resin, on the primer coating film formed by the foregoing formation method.

With the formation method for a coating film according to the present disclosure, a coating film excellent in adhesion to a metal substrate and corrosion resistance can be formed.

In a preferred embodiment of the formation method for a coating film according to the present disclosure, the finish coating composition contains a polyamide resin. In this case, the mechanical properties of the finish coating film are improved, so that a coating film suitable for use in metallic piping can be formed.

### Advantageous Effect

It is therefore possible to provide a primer composition capable of forming, in a short time, a primer coating film excellent in adhesion to a metal substrate, adhesion to a polyamide resin-containing finish coating film, and corrosion resistance.

It is also possible to provide a primer coating film excellent in adhesion to a metal substrate, adhesion to a polyamide resin-containing finish coating film, and corrosion resistance, a formation method for the primer coating film in a short time, and a formation method for a coating film excellent in adhesion to a metal substrate and corrosion resistance.

### DETAILED DESCRIPTION

A primer composition, a primer coating film and a formation method therefor, and a formation method for a coating film according to the present disclosure will be described in detail below, by way of embodiments.

<Primer Composition>

A primer composition according to the present disclosure contains a phenol resin (A), a polyamide resin (B), and a solvent (C), wherein the phenol resin (A) is a resol-type phenol resin, the polyamide resin (B) is soluble in the solvent (C), and a solid content mass ratio (A/B) between the phenol resin (A) and the polyamide resin (B) is 80/20 to 99/1.

In the primer composition according to the present disclosure, as a result of using a resol-type phenol resin as the phenol resin (A), a primer coating film can be formed from the primer composition in a short time, and also the solvent resistance of the formed primer coating film can be improved.

In the primer composition according to the present disclosure, as a result of containing the polyamide resin (B) soluble in the solvent (C), the adhesion of the primer coating film formed from the primer composition to a metal substrate and the adhesion of the primer coating film to a polyamide resin-containing finish coating film can be improved, and the corrosion resistance of the primer coating film can be improved.

In the primer composition according to the present disclosure, as a result of the solid content mass ratio (A/B) between the phenol resin (A) and the polyamide resin (B) being in the foregoing range, the adhesion of the primer coating film formed from the primer composition to a metal substrate and the adhesion of the primer coating film to a polyamide resin-containing finish coating film can be improved, and the corrosion resistance of the primer coating film can be improved.

Thus, the use of the primer composition according to the present disclosure enables formation of a primer coating film excellent in adhesion to a metal substrate, adhesion to a polyamide resin-containing finish coating film, and corrosion resistance in a short time.

(Phenol Resin (A))

The primer composition according to the present disclosure contains a resol-type phenol resin as the phenol resin (A). As a result of the primer composition containing a resol-type phenol resin, a primer coating film can be formed from the primer composition in a short time. If the primer composition does not contain a resol-type phenol resin, coating film formation in a short time is difficult, and the corrosion resistance of a primer coating film formed from the primer composition and the corrosion resistance of a coating film including the primer coating film decrease.

Examples of the resol-type phenol resin that can be used in the present disclosure include products obtained by condensing phenols such as carbolic acid (phenol), o-cresol, m-cresol, p-cresol, o-ethylphenol, m-ethylphenol, p-ethylphenol, 2,3-xylenol, 2,5-xylenol, 3,5-xylenol, m-methoxyphenol, p-methoxyphenol, bisphenol A, bisphenol B, and bisphenol F and formaldehyde using alkali catalysts such as ammonia, triethylamine, caustic soda, and caustic potash, and products obtained by alkyl etherifying them using alcohols such as methanol, ethanol, and n-butanol. Of these, carbolic acid, o-cresol, m-cresol, p-cresol, or a mixture thereof is preferably contained in the phenols, from the perspective of short-time coating film formability and corrosion resistance. Its content is preferably 60 mass % or more, more preferably 70 mass % or more, and most preferably 80 mass % or more with respect to the whole phenol compounds. If the content of carbolic acid, o-cresol, m-cresol, p-cresol, or a mixture thereof in the phenols is 60 mass % or more, short-time coating film formability and corrosion resistance are particularly high.

As the phenol resin (A), a commercial product may be used. Examples include SHONOL CKS-359Z, BKS-307, CKM-937, CKM-1737, CKM-1282, BKM-2620, and BLS-2700D produced by Aica Kogyo Co., Ltd., PHENOLITE UG-9106 and TD-799 produced by DIC Corporation, and SUMIRAC PC-1 and PC-25 produced by Sumitomo Bakelite Co., Ltd.

The phenol resin (A) preferably contains two or more methylol groups in one molecule. If the phenol resin (A) contains two or more methylol groups in one molecule, the phenol resin (A) has high reactivity. Therefore, the coating film formability is high, and the solvent resistance of the primer coating film formed from the primer composition can be further improved.

The number-average molecular weight of the phenol resin (A) is preferably 200 to 1,500, and further preferably 250 to 1,000. If the number-average molecular weight of the phenol resin (A) is 200 or more, the flexibility of the primer coating film formed from the primer composition can be improved, and the adhesion between the primer coating film and the polyamide resin-containing finish coating film can be further improved. If the number-average molecular weight of the phenol resin (A) is 1,500 or less, the primer composition has particularly good storage stability.

(Polyamide Resin (B))

The primer composition according to the present disclosure contains the polyamide resin (B) that is soluble in the solvent (C) (described later). As a result of the primer composition containing the polyamide resin (B) soluble in the solvent (C), the adhesion of the primer coating film formed from the primer composition to the metal substrate and the adhesion of the primer coating film to the polyamide resin-containing finish coating film can be improved, and the corrosion resistance of the coating film including the primer coating film can be improved. The polyamide resin (B) is any polyamide resin that is soluble in the solvent (C), and the molecular weight of the polyamide resin (B) is not limited. Examples of the polyamide resin (B) include polyamide 6 by ring-opening polymerization of ε-caprolactam, polyamide 66 by condensation polymerization of hexamethylenediamine and adipic acid, polyamide 610 by condensation polymerization of hexamethylenediamine and sebacic acid, polyamide 11 by condensation polymerization of 11-aminoundecanoic acid, and polyamide 12 by ring-opening polymerization of ω-laurolactam or condensation polymerization of 12-aminododecanoic acid. These polyamide resins may be selectively used as appropriate in combination with the solvent (C). These polyamide resins (B) may be used alone or in combination of two or more.

As the polyamide resin (B), a commercial product may be used. Examples include AQ Nylon A-90 and P-70 produced by Toray Industries, Inc., Flake Type (FINELEX) FR-101, FR-104, FR-105, and FR-301 and Solution Type (FINE RESIN) EM-120, EM-220, EM-325, and NK-1001 produced by Namariichi Co., Ltd., and PA-100, PA-100A, PA-102A, and PA-105A produced by T&K Toka Co., Ltd.

In the primer composition according to the present disclosure, the solid content mass ratio (A/B) between the phenol resin (A) and the polyamide resin (B) is 80/20 to 99/1, preferably in a range of 87.5/12.5 to 98/2, and further preferably in a range of 90/10 to 95/5. If the solid content mass ratio of the phenol resin (A) to the polyamide resin (B) is excessively low (i.e. if the ratio of the phenol resin (A) is excessively low), the adhesion of the primer coating film formed from the primer composition to the metal substrate and the adhesion of the primer coating film to the polyamide resin-containing finish coating film decrease, and the corrosion resistance of the coating film including the primer coating film decreases. If the solid content mass ratio of the phenol resin (A) to the polyamide resin (B) is excessively high (i.e. if the ratio of the phenol resin (A) is excessively high), the adhesion of the primer coating film formed from the primer composition to the metal substrate decreases.

(Solvent (C))

The primer composition according to the present disclosure contains the solvent (C), and the polyamide resin (B) is soluble in the solvent (C). Examples of the solvent (C) include water; glycol-based organic solvents such as ethylene glycol monobutyl ether (butyl cellosolve), diethylene glycol monobutyl ether, triethylene glycol monoethyl ether, propylene glycol monomethyl ether, propylene glycol monoethyl ether, propylene glycol monopropyl ether, dipropylene glycol monomethyl ether, dipropylene glycol monoethyl ether, and propylene glycol monomethyl ether acetate; alcohol-based organic solvents such as methanol, ethanol, isopropyl alcohol, isobutanol, and benzyl alcohol; ether-based organic solvents such as dioxane and tetrahydrofuran; ester-based organic solvents such as 3-methoxybutyl acetate, ethyl acetate, isopropyl acetate, and butyl acetate; ketone-based organic solvents such as methyl ethyl ketone, acetone, methyl isobutyl ketone, cyclohexanone, and isophorone; aliphatic hydrocarbon-based solvents such as pentane, iso-pentane, hexane, iso-hexane, and cyclohexane; and aromatic hydrocarbon-based solvents such as N-methyl-2-pyrrolidone, toluene, solvent naphtha, mineral spirits, Solvesso 100, and Solvesso 150 (Solvesso are both produced by Exxon Mobil Chemical Company). Of these, solvents having a permittivity of 10 F/m or more are preferable, and isobutanol and benzyl alcohol in alcohol-based organic solvents are further preferable. These solvents (C) may be used alone or in combination of two or more. The permittivity of the solvent is determined according to “Solvent Handbook” (published by Sangyo Tosho Co., Ltd., 1963).

The content of the solvent (C) is preferably in a range of 50 mass % to 400 mass % and more preferably in a range of 75 mass % to 300 mass %, with respect to a sum of the solvent (C) amount and the total solid content of the phenol resin (A) and the polyamide resin (B). If the content of the solvent (C) is in the foregoing range, the polyamide resin (B) can be uniformly distributed in the obtained coating film, which has the adhesion improving effect.

(Rust Preventive Pigment (D))

The primer composition according to the present disclosure preferably further contains a rust preventive pigment (D). If the primer composition contains the rust preventive pigment (D), the corrosion resistance of the primer coating film formed from the primer composition and the corrosion resistance of the coating film including the primer coating film can be further improved. Examples of the rust preventive pigment (D) include molybdate-based rust preventive pigments (zinc molybdate, strontium molybdate, etc.), phosphomolybdate-based rust preventive pigments (aluminum phosphomolybdate-based pigment, etc.), calcium silica-based rust preventive pigments, phosphate-based rust preventive pigments (magnesium triphosphate, zinc phosphite, aluminum-zinc tripolyphosphate, aluminum-magnesium tripolyphosphate, etc.), silicate-based rust preventive pigments, vanadium-based rust preventive pigments, and vanadate-based rust preventive pigments. These rust preventive pigments (D) may be used alone or in combination of two or more.

Of these rust preventive pigments (D), calcium silica-based rust preventive pigments and phosphate-based rust preventive pigments are preferable. If the rust preventive pigment (D) contains at least one rust preventive pigment selected from the group consisting of a calcium silica-based rust preventive pigment and a phosphate-based rust preventive pigment, the corrosion resistance of the primer coating film formed from the primer composition and the corrosion resistance of the coating film including the primer coating film can be further improved.

The content of the rust preventive pigment (D) is preferably in a range of 1 mass % to 40 mass % and further preferably in a range of 10 mass % to 25 mass %, with respect to the total solid content of the phenol resin (A) and the polyamide resin (B). If the content of the rust preventive pigment (D) is in the foregoing range, the corrosion resistance of the primer coating film formed from the primer composition and the corrosion resistance of the coating film including the primer coating film can be further improved.

(Curing Catalyst)

The primer composition according to the present disclosure may further contain a curing catalyst for the self-condensation of the phenol resin (A) described above. Examples of the curing catalyst include acid catalysts such as carboxylic acid and sulfonic acid. In particular, dodecylbenzenesulfonic acid and paratoluenesulfonic acid are preferably used. If the primer composition contains the curing catalyst, the primer coating film can be formed from the primer composition in a shorter time.

(Coupling Agent)

The primer composition according to the present disclosure may further contain at least one coupling agent selected from the group consisting of a silane-based coupling agent, a titanium-based coupling agent, and a zirconium-based coupling agent. If the primer composition contains the coupling agent, the adhesion of the primer coating film formed from the primer composition to the metal substrate can be further improved.

(Others)

The primer composition according to the present disclosure may contain other additives besides the foregoing components, within an extent not contrary to the object of the present disclosure. Examples of the other additives include extender pigments; colorants such as color pigments and dyes; luster pigments; ultraviolet absorbers (benzophenone-based ultraviolet absorbers, etc.); antioxidants (phenol-based, sulfide-based, hindered amine-based antioxidants, etc.); plasticizers; surface conditioners (silicone, organic polymers, etc.); anti-sagging agents; thickeners; lubricants such as wax; pigment dispersants; pigment wetting agents; leveling agents; antiflooding agents; suspending agents; anti-foaming agents; antiseptics; anti-freezing agents; emulsifiers; fungicides; antibacterial agents; and stabilizers. These additives may be used alone or in combination of two or more. A solvent other than the solvent (C) may also be contained.

Examples of the extender pigments include calcium carbonate, barium sulfate, clay, talc, mica, silica, alumina, and bentonite.

Examples of the color pigments include inorganic color pigments such as titanium dioxide, carbon black, graphite, iron oxide, and coal dust; organic color pigments such as phthalocyanine blue, phthalocyanine green, quinacridone, perylene, anthrapyrimidine, carbazole violet, anthrapyridine, azo orange, flavanthrone yellow, isoindoline yellow, azo yellow, indanthrone blue, dibromanzathrone red, perylene red, azo red, and anthraquinone red; and aluminum powders, alumina powders, bronze powders, copper powders, tin powders, zinc powders, iron phosphide, and atomized titanium. These may be used alone or in combination of two or more.

Examples of the luster pigments include foil pigments such as aluminum foil, bronze foil, tin foil, gold foil, silver foil, titanium metal foil, stainless steel foil, alloy foil of nickel and copper, etc., and foil-like phthalocyanine blue. These may be used alone or in combination of two or more.

(Preparation Method for Primer Composition)

The primer composition according to the present disclosure can be prepared, for example, by mixing the phenol resin (A), the polyamide resin (B), the solvent (C), and optional other additives using a mixer such as a roller mill, a ball mill, a bead mill, a pebble mill, a sand grind mill, a pot mill, a paint shaker, or a disperser.

<Primer Coating Film>

A primer coating film according to the present disclosure is formed using the foregoing primer composition. The primer coating film according to the present disclosure is excellent in adhesion to a metal substrate, adhesion to a polyamide resin-containing finish coating film, and corrosion resistance.

The film thickness (dry film thickness) of the primer coating film according to the present disclosure is typically 1 μm to 10 μm. If the film thickness of the primer coating film is in this range, the adhesion between the primer coating film and the metal substrate as well as the adhesion between the primer coating film and the finish coating film are sufficiently high.

<Formation Method for Primer Coating Film (Layer)>

A formation method for a primer coating film according to the present disclosure includes applying the foregoing primer composition onto a coated matter, and heating the coated matter having the primer composition applied thereon to 200° C. to 300 C, to form a primer coating film. With the formation method for a primer coating film according to the present disclosure, a primer coating film can be formed in a short time.

The coated matter on which the primer coating film according to the present disclosure is formed is not limited, but is preferably required to have corrosion resistance. A typical example is a steel sheet as a substrate of a precoated metal (coated steel sheet) or the like. Examples of the steel sheet of the coated steel sheet include a galvanized steel sheet, a cold rolled steel sheet, a stainless steel sheet, and an aluminum sheet. Examples of the galvanized steel sheet include zinc-containing coated steel sheets such as a hot-dip galvanized steel sheet, an electrogalvanized steel sheet, a galvannealed steel sheet, an aluminum-zinc coated steel sheet, a nickel-zinc coated steel sheet, a magnesium-aluminum-zinc coated steel sheet, and a magnesium-aluminum-silica-zinc coated steel sheet.

The steel sheet is preferably subjected to a surface treatment by a chemical conversion coating agent, before the coating. The surface treatment can be selected as appropriate depending on the steel sheet used. Examples include a chromate chemical conversion treatment, a phosphate chemical conversion treatment, and a metal oxide film treatment.

As the method of applying the primer composition to the coated matter, a conventionally known method such as a bar coater, a roll coater, an air spray, an airless spray, an electrostatic spray, a curtain flow coater, a dipping coater, or an air knife coater may be used.

In a preferred embodiment of the formation method for a primer coating film according to the present disclosure, the primer coating film can be formed by applying the primer composition to the coated matter such as a steel sheet and then performing a baking treatment of heating the coated matter. The baking treatment can be performed by a typical coating film baking means such as hot air heating, infrared heating, or high-frequency heating.

The baking temperature (the maximum temperature reached by the coated matter such as a steel sheet: highest material temperature) is typically 200° C. to 300° C., and the baking time is typically 1 sec to 200 sec.

<Formation Method for Coating Film>

A formation method for a coating film according to the present disclosure is a formation method for a coating film including a primer coating film and a finish coating film, and includes forming the finish coating film from a finish coating composition containing a thermoplastic resin, on the primer coating film formed by the foregoing method. With the formation method for a coating film according to the present disclosure, a coating film excellent in adhesion to a metal substrate and corrosion resistance can be formed.

As the thermoplastic resin contained in the finish coating composition, various thermoplastic resins can be used. Of the thermoplastic resins, a polyamide resin is preferable. If the finish coating composition contains a polyamide resin, the finish coating film contains the polyamide resin, so that the mechanical properties of the finish coating film can be improved and a coating film suitable for use in metallic piping can be formed.

A polyamide resin suitable for use in the finish coating composition may be the same as or different from the polyamide resin (B) used in the primer composition. Examples of the polyamide resin include polyamide 6 by ring-opening polymerization of c-caprolactam, polyamide 66 by condensation polymerization of hexamethylenediamine and adipic acid, polyamide 610 by condensation polymerization of hexamethylenediamine and sebacic acid, polyamide 11 by condensation polymerization of 11-aminoundecanoic acid, and polyamide 12 by ring-opening polymerization of w-laurolactam or condensation polymerization of 12-aminododecanoic acid.

Examples of the formation method for the finish coating film include a method of applying the finish coating composition onto the primer coating film by an applicator, heating and melting the finish coating composition at a temperature higher than or equal to the melting point of the thermoplastic resin, and then cooling it to form the finish coating film, and a method of heating and melting the finish coating composition at a temperature higher than or equal to the melting point of the thermoplastic resin and shaping the finish coating composition into a sheet to form the finish coating film. The formation method for the finish coating film is not limited to such, and may be any of various methods.

The film thickness (dry film thickness) of the finish coating film is preferably 50 μm to 300 μm. If the film thickness of the finish coating film is in this range, the corrosion resistance is sufficiently high.

### EXAMPLES

The presently disclosed techniques will be described in more detail below by way of examples, although the present disclosure is not limited to the examples below.

### Example 1

1.0 part by mass of AQ Nylon P-70 (produced by Toray Industries, Inc.) as a polyamide resin (B-1) and 9.0 parts by mass of isobutanol as a solvent (C-1) were placed in a container, and stirred by a disperser to dissolve the polyamide resin (B-1) in the solvent (C-1), thus obtaining a polyamide resin solution. Next, 198.0 parts by mass of SHONOL CKS-359Z (produced by Aica Kogyo Co., Ltd., resol-type phenol resin; solid content concentration: 50 mass %) as a phenol resin (A-1) were added to the obtained polyamide resin solution, and stirred by a disperser to obtain a primer composition.

### Examples 2 to 4 and 8 to 11

Each primer composition was obtained in the same way as in Example 1, using the types of phenol resin (A), polyamide resin (B), and solvent (C) shown in Table 1 in the blending amounts (parts by mass), the solid content mass ratios, and the contents shown in Tables 1 and 2. In Example 11, benzyl alcohol was used instead of isobutanol, as a solvent (C-2) added in the preparation of the primer composition.

### Example 5

7.5 parts by mass of AQ Nylon P-70 (produced by Toray Industries, Inc.) as the polyamide resin (B-1) and 67.5 parts by mass of isobutanol as the solvent (C-1) were placed in a container, and stirred by a disperser to dissolve the polyamide resin (B-1) in the solvent (C-1), thus obtaining a polyamide resin solution.

185.0 parts by mass of SHONOL CKS-359Z (produced by Aica Kogyo Co., Ltd., resol-type phenol resin; solid content concentration: 50 mass %) as the phenol resin (A-1), 10.6 parts by mass of SHIELDEX (produced by Fuji Silysia Chemical Ltd., silicon dioxide, calcium hydroxide) as a rust preventive pigment (D-1), and 10.6 parts by mass of PHOSPHINAL PZ04 (produced by SNCZ Co., zinc aluminum phosphate) as a rust preventive pigment (D-2) were added into a dispersion container, and glass beads were placed and dispersion was performed until the particle size became 10 μm or less to obtain a dispersion. The particle size herein was measured using a fineness gauge (in accordance with JIS K 5600-2-5 (dispersion degree)).

The polyamide resin solution prepared as described above was then mixed with the obtained dispersion and stirred by a disperser to obtain a primer composition.

### Examples 6 and 7

Each primer composition was obtained in the same way as in Example 5, using the types of phenol resin (A), polyamide resin (B), solvent (C), and rust preventive pigment (D) shown in Table 1 in the blending amounts (parts by mass), the solid content mass ratios, and the contents shown in Table 1.

### Comparative Examples 1 to 4

Each primer composition was obtained in the same way as in Example 1, using the types of phenol resin (A), polyamide resin (B), and solvent (C) shown in Table 2 in the blending amounts (parts by mass), the solid content mass ratios, and the contents shown in Table 2. In Comparative Example 1, the phenol resin (A) and the solvent (C) were used to yield a primer composition, without using the polyamide resin (B).

The compounds listed in Tables 1 and 2 are as follows:

Type of Phenol Resin (A)

(A-1) SHONOL CKS-359Z (produced by Aica Kogyo Co., Ltd., resol-type phenol resin; solid content concentration: 50 mass %, containing 23 mass % of diacetone alcohol, 14 mass % of n-butanol, 8 mass % of xylene, and 5 mass % of ethylbenzene as other compounds)

(A-2) SHONOL CKM-937 (produced by Aica Kogyo Co., Ltd., resol-type phenol resin; solid content concentration: 100%)

(A-3) SHONOL CKM-2103 (produced by Aica Kogyo Co., Ltd., novolac-type phenol resin; solid content concentration: 100 mass %)

(A-4) SHONOL CKM-1737 (produced by Aica Kogyo Co., Ltd., resol-type phenol resin; solid content concentration: 100 mass %).

Type of Polyamide Resin (B)

(B-1) AQ Nylon P-70 (produced by Toray Industries, Inc., polyamide resin)

(B-2) ORGASOL 2001 EXD NAT1 (produced by Arkema K.K., polyamide resin)

(B-3) AQ Nylon A-90 (produced by Toray Industries, Inc., polyamide resin).

In the “solubility” field of the polyamide resin (B), “good” indicates that the polyamide resin (B) was soluble in the solvent (C) used, and “poor” indicates that the polyamide resin (B) was insoluble in the solvent (C) used. Whether the polyamide resin (B) was soluble or insoluble was determined according to the following definition.

10 g of the polyamide resin (B) was added to 100 ml of the solvent (C), and stirred at 80° C. for 3 hr. The state of the resultant solution was visually evaluated based on the following criteria:

Good: colorless and transparent (soluble)

Poor: turbid with insoluble matter (insoluble).

Type of Solvent (C)

(C-1) isobutanol (permittivity: 18.9 F/m)

(C-2) benzyl alcohol (permittivity: 13.1 F/m)

(C-3) diacetone alcohol (permittivity: 18.2 F/m)

(C-4) n-butanol (permittivity: 17.1 F/m)

(C-5) xylene (permittivity: 2.6 F/m)

(C-6) ethylbenzene (permittivity: 2.4 F/m).

Type of Rust Preventive Pigment (D)

(D-1) SHIELDEX (produced by Fuji Silysia Chemical Ltd., calcium silica-based rust preventive pigment (silicon dioxide, calcium hydroxide))

(D-2) PHOSPHINAL PZ04 (produced by SNCZ, phosphate-based rust preventive pigment (zinc aluminum phosphate))

(D-3) EXPERT NP-1020C (produced by Toho Pigment Co., Ltd., phosphate-based rust preventive pigment (calcium phosphite))

(D-4) LF BOUSEI M-70L (produced by Kikuchi Color Co., Ltd., molybdate-based rust preventive pigment (zinc molybdate)).

<Production of Evaluation Test Piece>

Each primer composition was applied, with a bar coater, onto a hot-dip galvanized steel sheet (150 mm×100 mm×0.4 mm) whose surface had been chromated, so as to have a dry film thickness of 3 μm to 4 μm. The hot-dip galvanized steel sheet having the primer composition applied thereon was then immediately baked with a highest material temperature (peak metal temperature: PMT) of 250° C. for 3 sec using an IH drier, to form a primer coating film. In Example 8, the baking time was 1 sec.

Following this, a nylon powder (Rilsan Fine Powder ES Natural: produced by Arkema K.K.) was applied onto the primer coating film using an applicator so as to have a dry film thickness of 200 μm, heated and melted at 250° C. for 3 min, and then immediately submerged in water and cooled to form a finish coating film.

The solvent resistance, adhesion, and corrosion resistance of the obtained test piece were evaluated by the following methods.

<Solvent Resistance>

Each test piece was attached to an evaluation table of an abrasion resistance tester IMC-155F (produced by Imoto Machinery Co., Ltd.) with adhesive tape, and subjected to a rubbing test. The measurement conditions are as follows: A gauze containing methyl ethyl ketone was used as an abrasion material, with a load of 1 kg, a reciprocating speed of 30 times/min, and a reciprocating distance of 70 mm. The number of rubbing reciprocations until the base material of the base steel sheet was exposed was counted, and evaluation was performed according to the following criteria:

Excellent: the base material was not exposed even when the number of reciprocations was 100 or more.

Satisfactory: the base material was exposed when the number of reciprocations was 80 or more and less than 100.

Unsatisfactory: the base material was exposed when the number of reciprocations was 30 or more and less than 80.

Poor: The Base Material was Exposed when the Number of reciprocations was less than 30.

<Adhesion (cupping after grid cutting)>

Eleven vertical cuts and eleven horizontal cuts at intervals of 1 mm were made in the coating film of each test piece using a utility knife so as to reach the substrate, thus forming 100 squares. The part was subjected to 5 mm extrusion with a punch having a diameter of 20 mm from the back side of the coating surface of the test piece using a mechanical Erichsen tester ESM-1 (produced by Tokyo Koki Testing Machine Co., Ltd.), and the number of remaining squares out of the 100 squares was counted. Herein, 100/100 indicates that the peeling area of the coating film was 0% (no peeling). For example, 90/100 indicates that the peeling area of the coating film was 10%. The evaluation criteria are as follows:

Excellent: 100/100

Satisfactory: 95/100 or more and less than 100/100

Unsatisfactory: 90/100 or more and less than 95/100

Poor: less than 90/100.

A smaller peeling area of the coating film indicates better adhesion between the primer coating film and the metal substrate (base steel sheet) and/or between the primer coating film and the finish coating film.

<Corrosion Resistance (SST)>

A cut of 70 mm in length was made in each test piece using a utility knife so as to reach the substrate, and a salt spray test (SST) was conducted for 250 hr by a salt spray tester ST-11L (produced by Suga Test Instruments Co., Ltd.) in accordance with the test method for resistance to neutral spray defined in JIS K 5600-7-1 (JIS Z 2371). After the completion of the test, the cut portion was peeled, and the length of rust from the knife cut of the test piece was measured. The evaluation criteria are as follows:

Excellent: corrosion width of less than 15 mm

Very good: corrosion width of 15 mm or more and less than 20 mm

Good: corrosion width of 20 mm or more and less than 25 mm

Satisfactory: corrosion width of 25 mm or more and less than 35 mm

Unsatisfactory: corrosion width of 35 mm or more and less than 45 mm

Poor: corrosion width of 45 mm or more.

A smaller corrosion width indicates better corrosion resistance of the coating film.

TABLE 1

| | | | | | Example 1 | Example 2 | Example 3 | Example 4 |
|---|---|---|---|---|---|---|---|---|
| | | | Number | Number- | | | | |
| | | | of | average | | | | |
| | | | methylol | molecular | | | | |
| | | Type | groups | weight | | | | |
| Primer | Phenol | (A-1) | 3 | 480 | 198 | 185 | 160 | — |
| composition | resin | (A-2) | 2 | 700 | — | — | — | 92.5 |
| | (A) | (A-3) | 0 | 800 | — | — | — | — |
| | | (A-4) | 3 | 600 | — | — | — | — |
| | | | Solvent | | | | | |
| | | Type | solubility | | | | | |
| | Poly- | (B-1) | Good | | 1 | 7.5 | 20 | 7.5 |
| | amide | (B-2) | Poor | | — | — | — | — |
| | resin (B) | (B-3) | Good | | — | — | — | — |
| | (A)/(B) Solid content mass ratio | | | | 99/1 | 92.5/7.5 | 80/20 | 92.5/7.5 |
| | | Type | Contents | | | | | |
| | Solvent | (C-1) | Isobutanol | | 9 | 67.5 | 180 | 160 |
| | (C) | (C-2) | Benzyl | | — | — | — | — |
| | | | alcohol | | | | | |
| | | Content with | | | 108 | 160 | 260 | 160 |
| | | respect to total | | | | | | |
| | | solid content | | | | | | |
| | | of (A) and (B) | | | | | | |
| | | (mass %) | | | | | | |
| | | Type | Contents | | | | | |
| | Rust | (D-1) | Calcium | | — | — | — | — |
| | preventive | | silica- | | | | | |
| | pigment | | based | | | | | |
| | (D) | (D-2) | Phos- | | — | — | — | — |
| | | | phate- | | | | | |
| | | | based | | | | | |
| | | (D-3) | Phos- | | — | — | — | — |
| | | | phate- | | | | | |
| | | | based | | | | | |
| | | (D-4) | Molyb- | | — | — | — | — |
| | | | date- | | | | | |
| | | | based | | | | | |
| | | Content with | | | — | — | — | — |
| | | respect to total solid | | | | | | |
| | | content of (A) | | | | | | |
| | | and (B) (mass %) | | | | | | |
| Baking time (time at PMT 250° C.) (sec) | | | | | 3 | 3 | 3 | 3 |
| Evaluation | Solvent resistance | | | | Excellent | Excellent | Excellent | Satisfactory |
| items | Adhesion | | | | Satisfactory | Excellent | Satisfactory | Excellent |
| | Corrosion resistance | | | | Satisfactory | Satisfactory | Satisfactory | Satisfactory |
| | | | | | Example 5 | Example 6 | Example 7 | Example 8 |
| | | | Number | Number- | | | | |
| | | | of | average | | | | |
| | | | methylol | molecular | | | | |
| | | Type | groups | weight | | | | |
| Primer | Phenol | (A-1) | 3 | 480 | 185 | 185 | 185 | 185 |
| composition | resin | (A-2) | 2 | 700 | — | — | — | — |
| | (A) | (A-3) | 0 | 800 | — | — | — | — |
| | | (A-4) | 3 | 600 | — | — | — | — |
| | | | Solvent | | | | | |
| | | Type | solubility | | | | | |
| | Poly- | (B-1) | Good | | 7.5 | 7.5 | 7.5 | 7.5 |
| | amide | (B-2) | Poor | | — | — | — | — |
| | resin (B) | (B-3) | Good | | — | — | — | — |
| | (A)/(B) Solid content mass ratio | | | | 92.5/7.5 | 92.5/7.5 | 92.5/7.5 | 92.5/7.5 |
| | | Type | Contents | | | | | |
| | Solvent | (C-1) | Isobutanol | | 67.5 | 67.5 | 67.5 | 67.5 |
| | (C) | (C-2) | Benzyl | | — | — | — | — |
| | | | alcohol | | | | | |
| | | Content with | | | 160 | 160 | 160 | 160 |
| | | respect to total | | | | | | |
| | | solid content | | | | | | |
| | | of (A) and (B) | | | | | | |
| | | (mass %) | | | | | | |
| | | Type | Contents | | | | | |
| | Rust | (D-1) | Calcium | | 10.6 | — | — | — |
| | preventive | | silica- | | | | | |
| | pigment | | based | | | | | |
| | (D) | (D-2) | Phos- | | 10.6 | — | — | — |
| | | | phate- | | | | | |
| | | | based | | | | | |
| | | (D-3) | Phos- | | — | 21.2 | — | — |
| | | | phate- | | | | | |
| | | | based | | | | | |
| | | (D-4) | Molyb- | | — | — | 21.2 | — |
| | | | date- | | | | | |
| | | | based | | | | | |

| | | | | |
|---|---|---|---|---|
| Content with | 21.2 | 21.2 | 21.2 | — |
| respect to total solid | | | | |
| content of (A) | | | | |
| and (B) (mass %) | | | | |

| Baking time (time at PMT 250° C.) (sec) | | 3 | 3 | 3 | 1 |
|---|---|---|---|---|---|
| Evaluation | Solvent resistance | Excellent | Excellent | Excellent | Excellent |
| items | Adhesion | Excellent | Excellent | Excellent | Excellent |
| | Corrosion resistance | Excellent | Very good | Good | Satisfactory |

TABLE 2

| | | | | | | | | Comparative |
|---|---|---|---|---|---|---|---|---|
| | | | | | Example 9 | Example 10 | Example 11 | Example 1 |
| | | | Number | Number- | | | | |
| | | | of | average | | | | |
| | | | methylol | molecular | | | | |
| | | Type | groups | weight | | | | |
| | Phenol | (A-1) | 3 | 480 | — | 185 | 185 | 200 |
| Primer | resin | (A-2) | 2 | 700 | — | — | — | — |
| composition | (A) | (A-3) | 0 | 800 | — | — | — | — |
| | | (A-4) | 3 | 600 | 92.5 | — | — | — |
| | | | Solvent | | | | | |
| | | Type | solubility | | | | | |
| | Poly- | (B-1) | Good | | 7.5 | — | 7.5 | — |
| | amide | (B-2) | Poor | | — | — | — | — |
| | resin (B) | (B-3) | Good | | — | 7.5 | — | — |
| | (A)/(B) Solid content mass ratio | | | | 92.5/7.5 | 92.5/7.5 | 92.5/7.5 | 100/0 |
| | | Type | Contents | | | | | |
| | Solvent | (C-1) | Isobutanol | | 160 | 67.5 | — | — |
| | (C) | (C-2) | Benzyl alcohol | | — | — | 67.5 | — |
| | | Content with respect to | | | 160 | 160 | 160 | 100 |
| | | total solid content of (A) | | | | | | |
| | | and (B) (mass %) | | | | | | |
| | | Type | Contents | | | | | |
| | Rust | (D-1) | Calcium | | — | — | — | — |
| | preventive | | silica-based | | | | | |
| | pigment | (D-2) | Phosphate- | | — | — | — | — |
| | (D) | | based | | | | | |
| | | (D-3) | Phosphate- | | — | — | — | — |
| | | | based | | | | | |
| | | (D-4) | Molybdate- | | — | — | — | — |
| | | | based | | | | | |

| | | | | |
|---|---|---|---|---|
| Content with respect to total | — | — | — | — |
| solid content of (A) | | | | |
| and (B )(mass %) | | | | |

| Baking time (time at PMT 250° C.) (sec) | | 3 | 3 | 3 | 3 |
|---|---|---|---|---|---|
| Evaluation | Solvent resistance | Excellent | Excellent | Excellent | Excellent |
| items | Adhesion | Excellent | Satisfactory | Excellent | Unsatisfactory |
| | Corrosion resistance | Satisfactory | Satisfactory | Satisfactory | Satisfactory |

| | | | | | Comparative | Comparative | Comparative |
|---|---|---|---|---|---|---|---|
| | | | | | Example 2 | Example 3 | Example 4 |
| | | | Number | Number- | | | |
| | | | of | average | | | |
| | | | methylol | molecular | | | |
| | | Type | groups | weight | | | |
| | Phenol | (A-1) | 3 | 480 | 150 | — | 185 |
| Primer | resin | (A-2) | 2 | 700 | — | — | — |
| composition | (A) | (A-3) | 0 | 800 | — | 92.5 | — |
| | | (A-4) | 3 | 600 | — | — | — |
| | | | Solvent | | | | |
| | | Type | solubility | | | | |
| | Poly- | (B-1) | Good | | 25 | 7.5 | — |
| | amide | (B-2) | Poor | | — | — | 7.5 |
| | resin (B) | (B-3) | Good | | — | — | — |
| | (A)/(B) Solid content mass ratio | | | | 75/25 | 92.5/7.5 | 92.5/7.5 |
| | | Type | Contents | | | | |
| | Solvent | (C-1) | Isobutanol | | 225 | 160 | 67.5 |
| | (C) | (C-2) | Benzyl alcohol | | — | — | — |
| | | Content with respect to | | | 300 | 160 | 160 |
| | | total solid content of (A) | | | | | |
| | | and (B) (mass %) | | | | | |
| | | Type | Contents | | | | |
| | Rust | (D-1) | Calcium | | — | — | — |
| | preventive | | silica-based | | | | |
| | pigment | (D-2) | Phosphate- | | — | — | — |
| | (D) | | based | | | | |
| | | (D-3) | Phosphate- | | — | — | — |
| | | | based | | | | |
| | | (D-4) | Molybdate- | | — | — | — |
| | | | based | | | | |

| | | | |
|---|---|---|---|
| Content with respect to total | — | — | — |
| solid content of (A) | | | |
| and (B )(mass %) | | | |

| Baking time (time at PMT 250° C.) (sec) | | 3 | 3 | 3 |
|---|---|---|---|---|
| Evaluation | Solvent resistance | Excellent | Poor | Excellent |
| items | Adhesion | Unsatisfactory | Excellent | Unsatisfactory |
| | Corrosion resistance | Unsatisfactory | Poor | Unsatisfactory |

As can be understood from Tables 1 and 2, the primer composition of each Example according to the present disclosure was capable of forming a primer coating film in a short time, and the formed primer coating film was superior in adhesion to the metal substrate, adhesion to the polyamide resin, and corrosion resistance.

The primer coating film formed from the primer composition of Comparative Example 1 not containing the polyamide resin (B) had low adhesion.

The primer coating film formed from the primer composition of Comparative Example 2 in which the mass ratio of the phenol resin (A) to the polyamide resin (B) was excessively low had low adhesion and low corrosion resistance.

The primer coating film formed from the primer composition of Comparative Example 3 containing a novolac-type phenol resin instead of a resol-type phenol resin had low coating film formability and low solvent resistance, and therefore was not suitable for practical use. The primer coating film also had low corrosion resistance.

The primer coating film formed from the primer composition of Comparative Example 4 containing a polyamide resin insoluble in the solvent (C) instead of the polyamide resin (B) soluble in the solvent (C) had low adhesion and low corrosion resistance.

### INDUSTRIAL APPLICABILITY

The primer composition according to the present disclosure can be used for formation of a primer coating film. The primer coating film is excellent in adhesion to a metal substrate, adhesion to a polyamide resin-containing finish coating film, and corrosion resistance, and can be used for improvement in corrosion resistance of metallic piping.

1. A primer composition comprising:
a phenol resin (A);
a polyamide resin (B); and
a solvent (C),
wherein the phenol resin (A) is a resol-type phenol resin,
the polyamide resin (B) is soluble in the solvent (C), and
a solid content mass ratio (A/B) between the phenol resin (A) and the polyamide resin (B) is 80/20 to 99/1.

2. The primer composition according to claim 1, wherein the phenol resin (A) contains two or more methylol groups in one molecule.

3. The primer composition according to claim 1, wherein a number-average molecular weight of the phenol resin (A) is 200 to 1,500.

4. The primer composition according to claim 1, further comprising a rust preventive pigment (D).

5. The primer composition according to claim 4, wherein the rust preventive pigment (D) contains at least one rust preventive pigment selected from the group consisting of a calcium silica-based rust preventive pigment and a phosphate-based rust preventive pigment.

6. A primer coating film formed using the primer composition according to claim 1.

7. A formation method for a primer coating film, the formation method comprising
applying the primer composition according to claim 1 onto a coated matter, and heating the coated matter having the primer composition applied thereon to 200° C. to 300° C., to form the primer coating film.

8. A formation method for a coating film that includes a primer coating film and a finish coating film, the formation method comprising
forming the finish coating film from a finish coating composition containing a thermoplastic resin, on the primer coating film formed by the formation method according to claim 7.

9. The formation method for a coating film according to claim 8, wherein the finish coating composition contains a polyamide resin.

10. The primer composition according to claim 2, wherein a number-average molecular weight of the phenol resin (A) is 200 to 1,500.

11. The primer composition according to claim 2, further comprising a rust preventive pigment (D).

12. A primer coating film formed using the primer composition according to claim 2.

13. A formation method for a primer coating film, the formation method comprising
applying the primer composition according to claim 2 onto a coated matter, and heating the coated matter having the primer composition applied thereon to 200° C. to 300° C., to form the primer coating film.

14. The primer composition according to claim 3, further comprising a rust preventive pigment (D).

15. A primer coating film formed using the primer composition according to claim 3.

16. A formation method for a primer coating film, the formation method comprising
applying the primer composition according to claim 3 onto a coated matter, and heating the coated matter having the primer composition applied thereon to 200° C. to 300° C., to form the primer coating film.

17. A primer coating film formed using the primer composition according to claim 4.

18. A formation method for a primer coating film, the formation method comprising
applying the primer composition according to claim 4 onto a coated matter, and heating the coated matter having the primer composition applied thereon to 200° C. to 300° C., to form the primer coating film.

19. A primer coating film formed using the primer composition according to claim 5.

20. A formation method for a primer coating film, the formation method comprising
applying the primer composition according to claim 5 onto a coated matter, and heating the coated matter having the primer composition applied thereon to 200° C. to 300° C., to form the primer coating film.
